(19) United States
(12) Patent Application Publication
(10) Pub. No.: US 2025/0067929 A1
(43) Pub. Date: Feb. 27, 2025

(54) SYSTEMS, DEVICES, AND METHODS FOR GENERATING HIGHLY TWISTED STATES OF LIGHT FROM A HIGH-QUALITY FACTOR PHOTONIC CRYSTAL RING

(71) Applicants: University of Maryland, College Park, College Park, MD (US); Government of the United States of America, as Represented by the Secretary of Commerce, Gaithersburg, MD (US)

(72) Inventors: Xiyuan Lu, Montgomery Village, MD (US); Kartik Srinivasan, Rockville, MD (US)

(21) Appl. No.: 18/811,044

(22) Filed: Aug. 21, 2024

Related U.S. Application Data
(60) Provisional application No. 63/578,974, filed on Aug. 25, 2023.

(51) Int. Cl. G02B 6/12; G02B 6/124; G02B 6/293

(52) U.S. Cl. CPC G02B 6/12007; G02B 6/124; G02B 2006/12107; G02B 6/29341

(57) ABSTRACT

A device for generating high optical quality (high-Q) highly twisted states of light and a method for quantitative estimating a loss at all wavelengths, includes: a waveguide configured to couple to a light source; and a microresonator coupled to the light source via the waveguide, wherein the microresonator operates in whispering gallery mode (WGM). The microresonator includes a photonic crystal ring (PhCR) configured to enable generating highly twisted states of light, and a photonic crystal grating.

### CROSS-REFERENCE TO RELATED APPLICATION AND CLAIM OF PRIORITY

This application claims the benefit of, and priority to, U.S. Provisional Patent Application No. 63/578,974, filed on Aug. 25, 2023, the entire contents of which are hereby incorporated herein by reference.

### GOVERNMENT SUPPORT

This invention was made with government support under W911NF2120106 awarded by the Department of the Army and 70NANB14H209 awarded by the National Institute of Standards and Technology. The government has certain rights in the invention.

### TECHNICAL FIELD

The present disclosure relates generally to the field of nanophotonics. More specifically, the present disclosure provides systems and methods for generating highly twisted states of light from a high-quality factor photonic crystal ring.

### BACKGROUND

Many applications in quantum information science, metrology, and sensing require access to coherent laser light at a variety of wavelengths, ideally in a chip-integrated format suitable for scalable fabrication and deployment. While integrated photonics lasers are highly developed in the telecommunications band, many of the aforementioned technologies operate at other wavelengths. To this end, the extension of heterogeneously integrated lasers to other bands has been pursued, with recent demonstrations at 980 nm and 2000 nm. However, wavelength access across the entirety of a broad spectral range would demand the challenging integration of several material platforms.

Accordingly, there is interest in enabling the generation of highly twisted states of light from a high-quality factor photonic crystal ring.

### SUMMARY

An aspect of the present disclosure provides a system for generating highly twisted states of light. The system includes a light source configured to pump light and a photonic device configured to enable generation of highly twisted states of light. The photonic device includes a waveguide configured to couple to the light source and a microresonator coupled to the light source via the waveguide, wherein the microresonator operates in whispering gallery mode (WGM). The microresonator includes a photonic crystal ring (PhCR) configured to enable generating highly twisted states of light, and a photonic crystal grating.

In accordance with aspects of the disclosure, a quality factor of the microresonator may be greater than or equal to about 10⁵.

In accordance with aspects of the disclosure, the WGM may include an azimuthal order m representing angular momentum of the WGM, and a grating with N periods around a circumference of the PhCR.

In accordance with aspects of the disclosure, the microresonator may be configured to eject light carrying orbital angular momentum (OAM) with an angular momentum number (l)=m−N.

In accordance with aspects of the disclosure, the microresonator may be configured to generate OAM states up to an l of about 60, with an estimated upper bound of OAM ejection efficiency of up to about 90%.

In accordance with aspects of the disclosure, when

$$m = \frac{N}{2} ,$$

a clockwise WGM and a counterclockwise WGM may be coupled by the photonic crystal grating.

In another aspect of the present disclosure, the microresonator and the waveguide may be on a common substrate.

In another aspect of the present disclosure, an inside radius of the PhCR may be modulated as Rᵢₙ=Rᵢₙ⁰+A cos(Nφ), where Rᵢₙ⁰ is an average inside radius, A is a modulation amplitude, and φ is an azimuthal angle.

In another aspect of the present disclosure, the grating may include periodical modulation in one dimension.

In yet another aspect of the present disclosure, an interaction rate between two counter-propagating WGMs may be mediated by selective mode splitting (SMS).

In accordance with further aspects of the present disclosure, a method for generating highly twisted states of light includes pumping a light from a light source, and coupling, by a waveguide, the light source to a photonic device configured to enable generating highly twisted states of light. The photonic device includes a waveguide configured to couple to the light source and a microresonator operating in whispering gallery mode (WGM). The microresonator includes a photonic crystal ring (PhCR) configured to enable generating highly twisted states of light. The microresonator further includes a photonic crystal grating.

In another aspect of the present disclosure, the WGM may include an azimuthal order m representing angular momentum of the WGM, and a grating with N periods around a circumference of the PhCR.

In another aspect of the present disclosure, the method may further include ejecting light carrying orbital angular momentum (OAM) with an angular momentum number (l)=m−N, by the microresonator.

In an aspect of the disclosure, the method may further include generating OAM states up to an l of about 60, with an estimated upper bound of OAM ejection efficiency of up to about 90%.

In an aspect of the present disclosure, the method may further include coupling, by the photonic crystal grating, when

$$m = \frac{N}{2} ,$$

a clockwise WGM and a counterclockwise WGM.

In an aspect of the present disclosure, the method may further include mediating by selective mode splitting (SMS) an interaction rate between two counter-propagating WGMs.

In accordance with further aspects of the present disclosure, a photonic device for generating highly twisted states of light is presented. The photonic device includes a waveguide configured to couple to a light source and a microresonator coupled to the light source via the waveguide. The microresonator operates in whispering gallery mode (WGM). The microresonator includes a photonic crystal ring (PhCR) configured to enable generating highly twisted states of light. The microresonator further includes a photonic crystal grating.

In an aspect of the present disclosure, a quality factor of the microresonator may be greater than or equal to about 10′.

In an aspect of the present disclosure, the WGM may include an azimuthal order m representing angular momentum of the WGM, and a grating with N periods around a circumference of the PhCR.

In an aspect of the present disclosure, an inside radius of the PhCR may be modulated as Rᵢₙ=Rᵢₙ⁰+A cos(Nφ), where Rᵢₙ⁰ is an average inside radius, A is a modulation amplitude, and φ is an azimuthal angle.

In accordance with further aspects of the present disclosure, a method for quantitatively estimating a rate of vertical orbital angular momentum (OAM) emission includes: selecting a selective mode splitting (SMS) reference microresonator with a known SMS rate; and estimating a rate of vertical OAM emission based on a link between OAM and SMS by the following equations to predict OAM loss in a photonic device for generating highly twisted states of OAM light:

$${κ}_{e} = {q}_{0} \frac{2 β}{\sqrt{{F}_{t} / 2 π}} cos ( θ )$$

and κₜ=κₜ⁰+2q\sqrt{κₜ}. The photonic device includes a waveguide configured to couple to a light source; and a microresonator coupled to the light source via the waveguide. The microresonator operates in whispering gallery mode (WGM). The microresonator includes a photonic crystal ring (PhCR) configured to enable generating highly twisted states of OAM light. The microresonator includes a photonic crystal grating configured to enable SMS of WGM. A strength of the coupling from the WGM to a free-space OAM mode is quantified by a rate κₑ of the reference microresonator.

Further details and aspects of exemplary embodiments of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings of which:

FIG. 1 is a diagram of an exemplary device for generating highly twisted states of light, in accordance with examples of the present disclosure;

FIG. 2 is a graph of transmission vs resonance frequency ω for a whispering gallery mode (WGM) using the device of FIG. 1, in accordance with examples of the present disclosure;

FIG. 3 is a diagram illustrating a free space OAM mode of the device of FIG. 1, in accordance with examples of the present disclosure;

FIG. 4 is a diagram illustrating a band diagram for OAM and selective mode splitting (SMS) of the device of FIG. 1, in accordance with examples of the present disclosure;

FIG. 5 is a diagram illustrating the mode splitting of an example SMS device, in accordance with examples of the present disclosure;

FIG. 6 is a diagram illustrating OAM emission and self-interference of the device of FIG. 1, in accordance with examples of the present disclosure;

FIG. 7 is a diagram of a simulation illustrating clockwise and counter-clockwise dipole excitation in accordance with examples of the present disclosure;

FIG. 8 is a graph illustrating the simulated visibility of the simulation of FIG. 7, in accordance with examples of the present disclosure;

FIG. 9 is a diagram illustrating the OAM ejection rate, in accordance with examples of the present disclosure;

FIG. 10 is a set of graphs illustrating data for the example SMS device of FIG. 5, in accordance with examples of the present disclosure;

FIG. 11 is a graph illustrating the OAM cavity line widths, in accordance with examples of the present disclosure;

FIG. 12 is a set of infrared images the surface of the OAM microrings of the device of FIG. 1, in accordance with examples of the present disclosure;

FIG. 13 is a set of predicted patterns from three-dimensional finite-difference time-domain simulations using dipole excitation, in accordance with examples of the present disclosure;

FIG. 14 is a diagram illustrating a band diagram when OAM and SMS are coherently implemented together, in accordance with examples of the present disclosure;

FIG. 15 is a diagram illustrating an expected transmission spectrum of the band diagram of FIG. 14, in accordance with examples of the present disclosure;

FIGS. 16 and 17 are diagrams illustrating three example devices with the same OAM modulation, but different SMS modulation, in accordance with examples of the present disclosure;

FIG. 18 is a set of graphs illustrating normalized transmission spectra for the t=0 and l=−1 modes, in accordance with examples of the present disclosure;

FIG. 19 is a set of images of the emitted light from different l orders taken from the device of FIG. 1, in accordance with examples of the present disclosure;

FIG. 20 is a set of predicted far-field patterns from the three-dimensional finite-difference time-domain simulations, in accordance with examples of the present disclosure; and

FIG. 21 is a graph illustrating quality factor measurements across a full range of ratios of the number of modulation periods to azimuthal mode number, in accordance with examples of the present disclosure.

### DETAILED DESCRIPTION

The present disclosure relates generally to the field of nanophotonics. More specifically, the present disclosure provides systems, devices, and methods for generating highly twisted states of light from a high-quality factor photonic crystal ring.

Although the present disclosure will be described in terms of specific examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

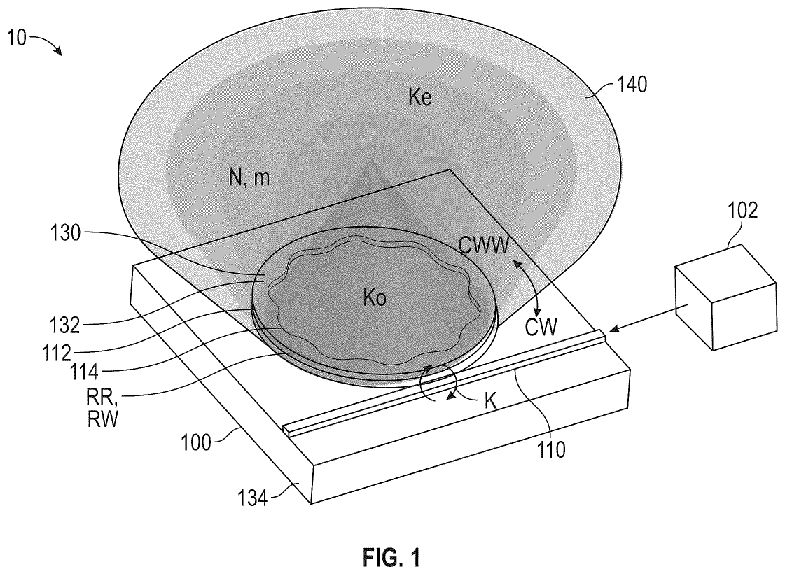

Referring to FIG. 1, a diagram of an example system 10 and device 100 for generating highly twisted states of light is shown. Device 100 is configured for on-chip highly twisted states of light generation. Device 100 provides the benefit of supporting high angular momentum and enables OAM-carrying states.

System 10 may include a light source 102 (e.g., pump) configured to pump a laser light, and device 100 configured to generate highly twisted states of light. Device 100 generally includes a waveguide 110 and a compact microresonator 130 (e.g., a microring resonator) configured to generate highly twisted states of light. Microresonator 130 may include a photonic crystal ring (PhCR). The PhCR includes a photonic crystal grating. Microresonator 130 may operate in whispering gallery mode (WGM) 140. In aspects, OAM and elective mode splitting (SMS) may be coherently implemented together. The term compact, as used herein, includes sub 100×100-micrometer devices.

The waveguide 110 is configured to couple the light source 102 to the microresonator 130. The waveguide 110 may be comprised of, for example, silicon nitride and/or silicon oxynitride or other such suitable materials.

The microresonator 130 generally includes a layer 132 comprised of silicon nitride (Si₃N₄) and a substrate 134 comprised of silicon dioxide (SiO₂). It is contemplated that other suitable materials may be used for substrate 134 and for layer 132. For example, layer 132 material may include sapphire, quartz, MgF₂, or any material with a similar refractive index. Layer 132 includes a ring width (RW), which can be configured for tuning the microresonator 130, and a ring radius (RR). The diameter of the ring and the ring width determine the resonant wavelengths. Microresonator 130 may include a cladding comprised of air. The cladding may be disposed on a first side of layer 132. In aspects, microresonator 130 may further include a layer of silicon (Si) disposed on a second side of substrate 134. Other suitable material stack-ups are contemplated. In aspects, microresonator 130 and waveguide 110 may be either on the same layer or on different layers of a common substrate 134.

As a property of photons, orbital angular momentum (OAM), with an angular momentum number (l) provides an additional dimension to encode information. This extra information capacity may be harnessed in holography, multiplexed communications, quantum entanglement, and cryptography.

On-chip OAM generation using integrated photonics, such as used in system 100, can advance more widespread use of OAM functionalities, for example, through whispering gallery mode (WGM) microresonators (e.g., microresonator 130). The WGMs in such resonators are bound modes that support high angular momentum, and OAM-carrying states can be realized if a suitable means to eject such WGMs into free space is incorporated, e.g., through a grating inscribed on the resonator. A WGM device with an azimuthal order m, and a grating with N periods around the resonator circumference, will eject light carrying OAM with an angular momentum number (l)=m−N.

The WGM approach is distinguished by the ability to simultaneously enhance light-matter interactions through the microresonator's high-quality factor (Q) and small mode volume (V). To maximize the microresonator's ability to enhance interactions while ejecting light into an OAM state, the microresonator's high-Q should be retained even in the presence of the ejection grating, with the degradation in Q relative to a conventional resonator (no grating) being exclusively due to the new coupling channel into the free-space OAM mode. As used herein, a high-Q generally includes a Q of higher than about 10⁵. This behavior should hold for a wide range of l, to fully enable the spatial multiplexing at the heart of OAM's potential in quantum and classical communications. However, existing demonstrations of OAM-generating microresonators have been limited to a Q of lower than 10³ and have focused on relatively low-l OAM states. These two limits for OAM in WGMs are in large part due to the lack of quantitative understanding of the relationship between Q and OAM ejection efficiency and l.

Improving Q in OAM-generating resonators has numerous implications. For example, in single quantum emitter systems, higher Qs would produce stronger Purcell enhancement to improve the indistinguishability and spontaneous emission coupling fraction of OAM single photons, with the further possibility of entering the non-perturbative strong coupling regime of cavity QED. A second example is spatiotemporal shaping of light, where the ability to control both the spatial and temporal degrees of freedom of light is of fundamental interest and can lead to new abilities for optical manipulation. Recently, dynamic spatiotemporal control has been explored in the context of coherent addition of optical frequency comb components that carry different amounts of OAM. Recent advances in frequency comb generation through nonlinear wave mixing in microresonators suggest its potential in such research, but the limited Qs of OAM microresonators and the lack of understanding of these limits have prevented any serious investigation of such opportunities. System 10 provides the benefit of enabling these uses.

System 10 and device 100 may be used for laser injection locking. This is a technique where a weaker signal (the injection signal) from a stable laser is injected into another laser (the slave laser) to stabilize or control its output. The slave laser can then emit light at the frequency of the injected signal, resulting in a cleaner, more stable output. This is often used in applications requiring precise control of the laser frequency, such as in communication systems or spectroscopy.

System 10 and device 100 may be used for quantum optics, for example, ion trapping. Ion trapping is a technique used to confine ions (charged atoms) in a small region of space using electromagnetic fields. Trapped ions are isolated from their environment, making them ideal for precision experiments and quantum information processing. For example, optical tweezers traditionally use focused laser beams to trap and manipulate small particles, including neutral atoms or ions, by exerting a gradient force. When light carries OAM, such as provided by system 10 and device 100, the beam has a helical phase front and a doughnut-shaped intensity profile, which can be used to create complex trapping potentials. This can be used to trap ions, for example, trapping ions in ring structures or controlling their angular position with the twisted light. In another example, system 10 and device 100 may be used for angular momentum transfer. The OAM of light can be transferred to trapped particles, including ions, allowing for precise control over their rotational motion. Using OAM for angular momentum transfer may enable new ways of manipulating the internal states of ions, such as their spin or motional degrees of freedom, which is useful in quantum information processing. In another example, OAM can be used for quantum state control. For example, the entanglement of orbital states or state preparation and control.

System 10 includes a chip-integrated, high-Q (e.g., about 10⁵ to about 10⁶) microresonator 100 that generates high-l OAM states (up to l=60) with a high estimated upper bound of OAM ejection efficiency (up to 90%). Also provided is a model that predicts the OAM ejection efficiency and the microresonator's 100 total dissipation rate and scaling with l. This is done by considering how OAM generation is one manifestation of grating-assisted coupling in the microresonator 100. In particular, a connection is established between OAM ejection and mode-selective backscattering, known as SMS, and illustrates how measurements of SMS devices enable quantitative predictions of OAM behavior that are well-matched by experiments. Along with performance that dramatically exceeds previous studies in terms of Q and accessible OAM states, system 100 may be used in the context of nonlinear and quantum light sources.

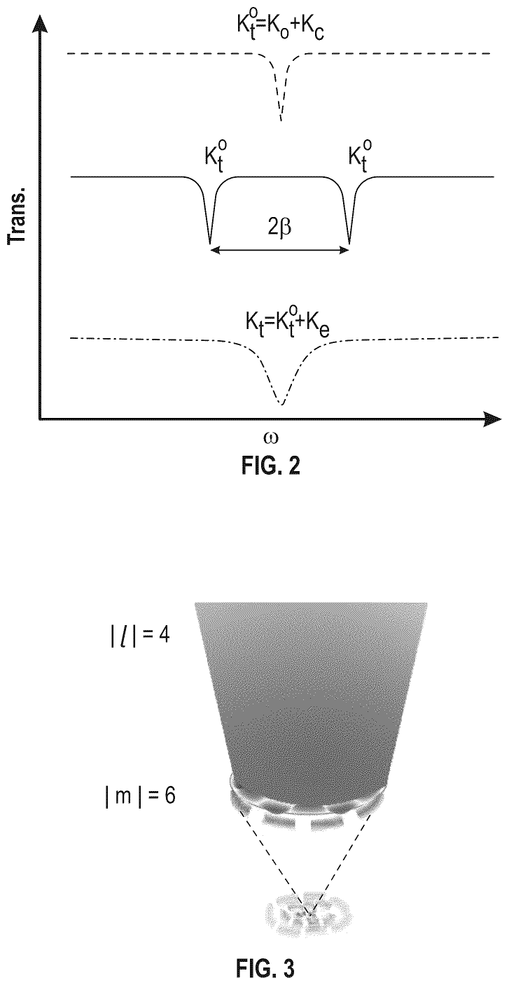

OAM ejection from a WGM is based on the basic angular momentum conservation criterion between the initial WGM with angular momentum m, the imprinted grating with N periods along the ring circumference, and the resulting ejected OAM state with l=m−N, as illustrated in FIGS. 1 and 3. The strength of the coupling from the WGM to the free-space OAM mode is quantified by a rate κₑ. This coupling leads to additional broadening of the total cavity linewidth, given by κₜ=κₜ⁰+κₑ, where κₜ⁰ includes the WGM intrinsic loss rate κ₀ and waveguide coupling rate κ_{c}, which is well-understood in conventional microrings. Such broadening is illustrated in FIG. 2. On the other hand, the interaction rate between two counter-propagating WGMs mediated by an imprinted grating, termed selective mode splitting (SMS), is well-understood at a quantitative level. An example is a photonic crystal ring (PhCR), as shown in FIG. 1. The inside radius of the PhCR is modulated as Rᵢₙ=Rᵢₙ⁰+A cos(Nφ), where Rᵢₙ⁰ is the average inside radius, A is the modulation amplitude, N is the number of periods of the grating, and φ is the azimuthal angle. Each WGM in the PhCR is characterized by an azimuthal mode number m, representing its angular momentum, that is, the number of electric field oscillations around the device perimeter within one round trip. When m=N/2, the clockwise and counterclockwise WGMs are coupled by the photonic crystal grating. This coupling renormalizes two propagating modes into two standing-wave modes that see a narrower and a wider ring on average and, therefore, have a smaller and larger resonance wavelength or, equivalently, a higher and lower center resonance frequency (ω_{±}=ω₀±β), respectively, as illustrated in FIG. 5, where coo is the uncoupled (clockwise or counter-clockwise propagating) mode frequency. The coupling rate β is simply given by β=gA, where A is the modulation amplitude of the inside radius and g=∂ω/∂Rᵢₙ at Rᵢₙ=Rᵢₙ⁰, with co the angular frequency of the WGM. g can be understood as the geometric dispersion with respect to the inside radius of an unmodulated ring. It is also equivalent to the per photon force (divided by h) on the inside boundary of an unmodulated ring. SMS WGMs remain high-Q (Qₜ⁰=ω/κₜ⁰), with κₜ⁰ remaining the same as a conventional microring, that is, κₜ⁰=κ₀+κ_{c}, as illustrated in FIG. 2. The modulation may be used to decide the parameters for devices with high-Q OAM emission.

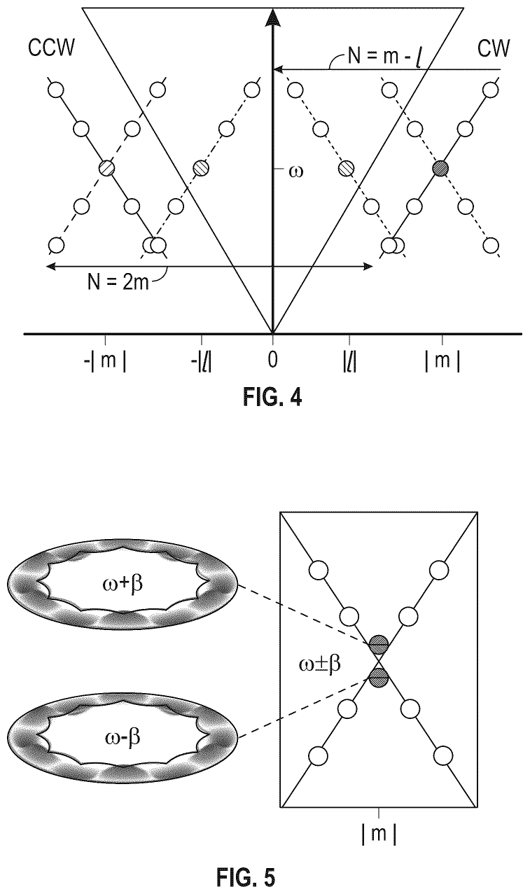

The number of periods in the grating (N) is the only difference in device geometry between the SMS and OAM devices (e.g., microresonator 100), with N=m−l for the OAM light carrying l momentum and N=2m for SMS. The geometries of the OAM and SMS devices are illustrated in FIG. 1, with their momentum-frequency diagrams shown in FIG. 4. The OAM mode is ejected from the device and cannot interact with the WGM after emission, as shown in FIG. 1, while clockwise and counter-clockwise WGMs can scatter back and forth, as shown in FIG. 1. In the band diagram shown in FIG. 4, the OAM emission is illustrated by a red arrow and the SMS coupling is illustrated by a purple double-ended arrow, assuming the waveguide initially couples light into the WGM in the clockwise direction. FIG. 2 shows the expected transmission spectra of the control device (without modulation), the SMS case, and the OAM case. Compared to the control device, the SMS device shows a frequency splitting but no linewidth broadening, while the OAM device shows a linewidth broadening but no frequency splitting.

Referring to FIG. 3, in the OAM device, the grating with N=10 ejects the clockwise mode with m=6 into a free space OAM mode carrying a momentum of l=4 at a rate of kₑ. The OAM emission leads to a broadening if the cavity line width. When the WGM is a standing wave with m=±6 or there is a reflection in the microring chip facet the observed OAM mode has l=±4, which bis manifested in the intensity profile of the WGM, exhibiting four pairs of anti-nodes.

From coupled-mode equations for OAM and SMS, a link is proposed between OAM and SMS given by:

$${κ}_{e} = {q}_{0} \frac{2 β}{\sqrt{{F}_{t} / 2 π}} cos ( θ ) \qquad Eqn . ( 1 )$$

κₑ and β have the same units (both are rates), while all other parameters here are unitless. q₀ is a constant, and Fₜ is the cavity mode finesse given by Fₜ=Qₜ/m=ω/(mκₜ), where Qₜ, ω, and κₜ are the total optical quality factor, cavity resonance angular frequency, and total cavity linewidth, respectively.

WGM with an angular momentum of m in the microring and an angular momentum of l=m−N in the OAM emission. θ=(l/m)(π/2) represents the nominal twisted angle of the ejected OAM modes with respect to the vertical direction. Writing κₜ in terms of its original value with no OAM emission (κ⁰) and OAM emission rate (κₑ) results in:

$${κ}_{t} = {κ}_{t}^{0} + 2 q \sqrt{{κ}_{t}} \qquad Eqn . ( 2 )$$

κ₀ includes the cavity intrinsic loss rate and waveguide-ring coupling rate, so that κₜ⁰=κ₀+κ_{c}. q is related to κₑ and κₜ by κₑ=2q\sqrt{κₜ}, with

$$q = {q}_{0} β \sqrt{\frac{m}{v}} cos ( θ )$$

(see Eqn. (1)). Eqn. (2) is a quadratic function and its solution is given by:

$$\sqrt{{κ}_{t}} = q + \sqrt{{q}^{2} + {κ}_{t}^{0}} , \qquad Eqn . ( 3 )$$

where the other solution is negative and discarded.

From these equations, a few initial observations can be made. In the SMS case, where l=−m, (N=2m), the cosine term vanishes so that q and κₑ are zero. This is consistent with previous observations where κₜ is barely affected by the grating modulation as long as N=2m. When l=0, i.e., N=m, corresponding topologically to the LG₀₁ mode in the Laguerre-Gaussian basis of modes (LGₗₚ, where l represents the angular momentum number and p represents the radial momentum number), the cosine term is equal to one. In this case, when β and κe are small, the cavity linewidth asymptotically approaches that of the unmodulated microring (κₜ≈κₜ⁰). When κₑ is large compared to κₜ⁰, the OAM ejection channel is the dominant cavity loss channel (κₜ≈κₑ). Finally, it is suggested that κₑ∝cos(θ), i.e., that the OAM ejection rate is linearly proportional to the momentum projected in the vertical direction after the grating's momentum is exerted on the WGM. This assumption requires experimental verification.

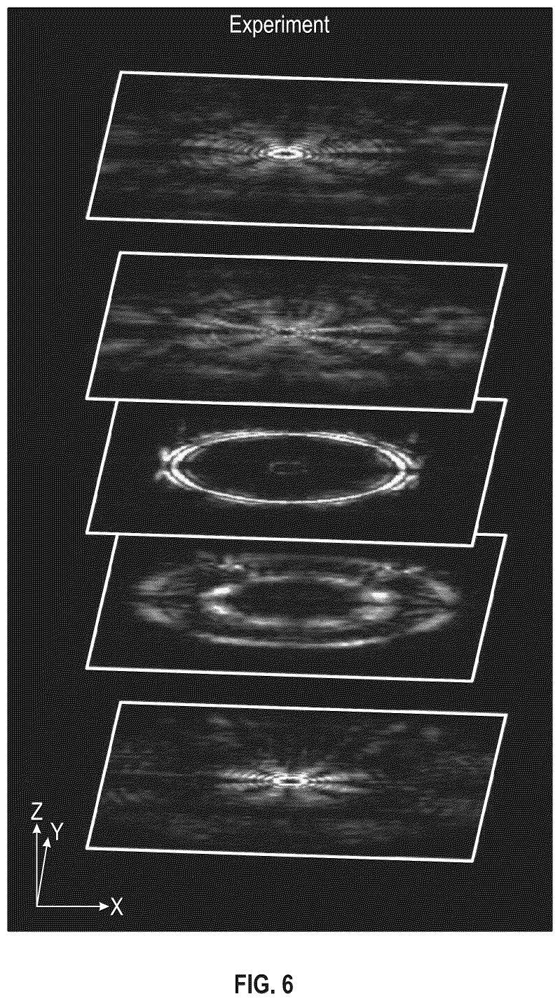

SMS and OAM devices in stoichiometric silicon nitride were designed and fabricated following the prescription of the previous section. Representative experimentally measured infrared images of the light ejected from one OAM device at various z (vertical) planes are shown in FIG. 6. This device has m=165 and N=169, and the infrared images show OAM light with |l|=4.

The OAM emission direction here is mainly vertical with a divergence angle but also has a radial contribution with a Bessel pattern, as shown in FIG. 6. This Bessel pattern is known to be generated when a plane wave passes through a ring slit and is focused by a lens. In the case at hand, the ring slit is naturally there by the WGMs within the microring, and the focusing is provided by the transferring of the angular momentum of the WGM to the OAM light by the inner sidewall grating. A Bessel pattern refers to the intensity distribution of light that results when a Bessel beam is formed. A Bessel beam is a type of non-diffracting wave that exhibits a central bright spot surrounded by concentric rings of decreasing intensity. Unlike a Gaussian beam, which spreads out as it propagates, a Bessel beam maintains its shape over a long distance.

A feature of the OAM beam is the helical property carrying its orbital angular momentum. In a microring, it is represented by the angular momentum number l, assuming E(r,z)≈E₀(r,z)e^{ilφ}e^{ikz}. This simplified representation is made possible because of the rotational symmetry of a microring, and in a more complicated case (for example, in a racetrack ring), this simple equation may not hold, though a generalized l can still be used to describe the topological behavior. This helical feature has been confirmed by interference with left-/right-hand polarized beams or self-interference with an offset. This feature is observed by self-interference in the microring, which results in a 2|l|intensity beating pattern. For example, in FIG. 4, there are interference patterns with 4×2 nodes in both the mid-field and far-field that are from the interference of OAM light with l=−4 and l=4. These interference patterns rotate slowly when propagating in the z direction, likely due to the difference (in either propagation speed or spatial pattern) between the emitted ±l light.

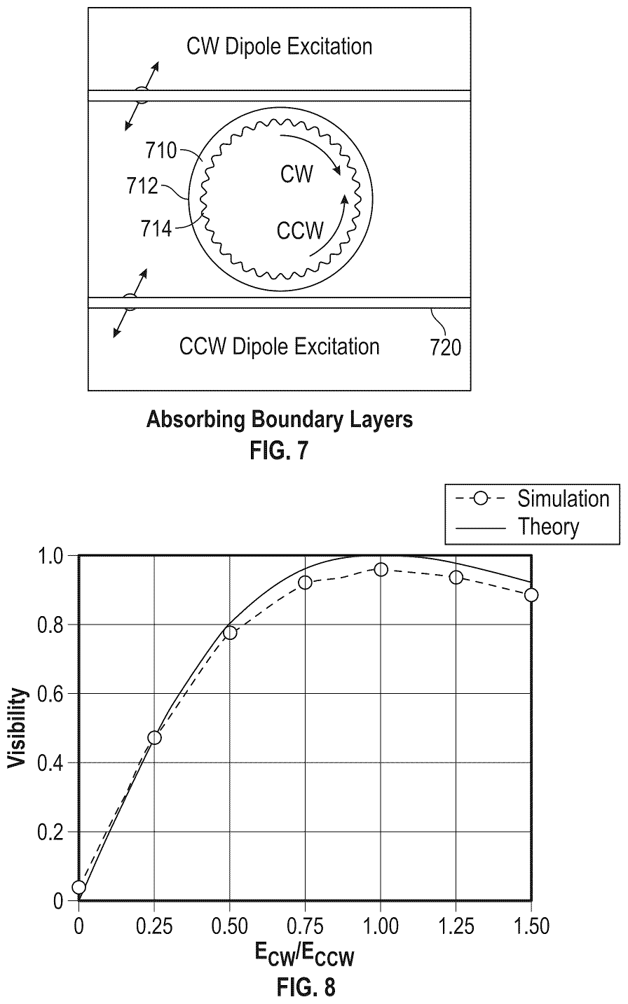

Such an intensity interference pattern is mainly attributable to the in-plane reflection channels from (1) the chip facets, (2) backscattering within the microring, and (3) the air/oxide cladding interface. The ending result of these three channels are equivalent and can be simulated by the structure shown in FIG. 7. The simulated radiation pattern has a visibility in intensity with 2l beating nodes, where the visibility is calculated by (|E|ₘₐₓ²−|E|ₘᵢₙ²)/(|E|ₘₐₓ²+|E|ₘᵢₙ²), with |E|² extracted from a full 2D finite-difference time-domain simulation. As shown in FIG. 8, the simulated results agree with a simple theoretical prediction of |E_{cw} cos(lθ)+E_{ccw} cos(−lφ)|². The visibility vanishes when there is no reflection (only counter-clockwise (CCW) dipole, no clockwise (CW) dipole) and equals unity when E_{cw}/E_{ccw}=1 (CW and CCW dipoles have the same strength). The out-of-plane reflections are not mainly responsible for creating such patterns in the current case.

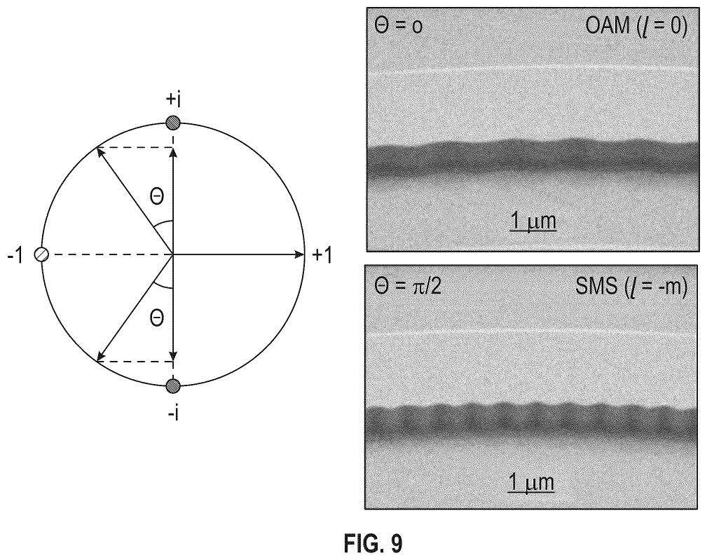

The close connection between SMS and OAM devices, with representative devices, is shown in FIGS. 1 and 9. The length of a modulation period, given by 2πR/N, is twice as long in this OAM device (N=m, i.e., l=0) as in the SMS device (N=2m), but all other parameters are kept the same. A series of devices for SMS and OAM were fabricated, varying N while keeping the device geometry otherwise fixed. Studying modes of the same azimuthal order m and similar resonance frequency ω seeks to limit the impact of any systematic variation in intrinsic and coupling Q (e.g., with frequency, ring width, thickness, refractive index, etc.), enabling focus on how κₜ and κₑ vary with l=m−N.

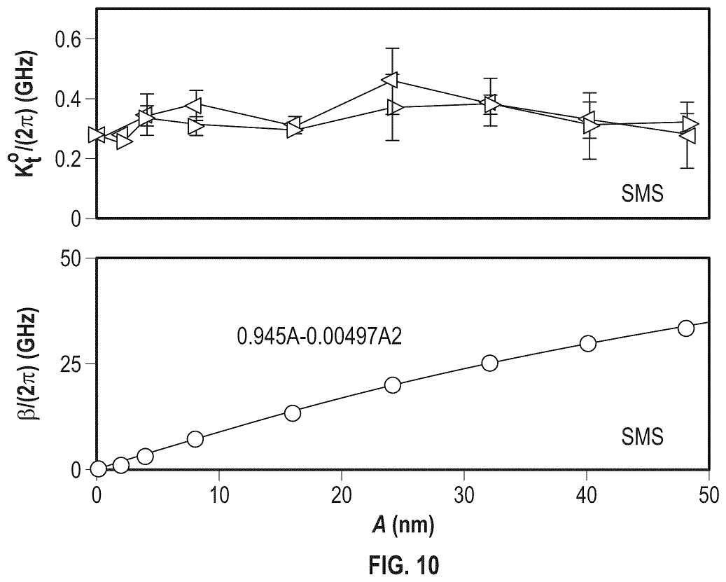

The SMS results are summarized in FIG. 10. The total cavity linewidths (κₜ⁰) see no change to within measurement uncertainty when A increases and the mode splitting (2β) is essentially linearly dependent on A, when the splitting is >10× smaller than the free spectral range (e.g., approximately 1 THz in these devices). The error bars represent 95% confidence intervals from nonlinear least squares fits to the SMS transmission data. The measured κₜ⁰/2π≈0.3 GHz corresponds to a Qₜ⁰≈6.4×10⁵ at 1560 nm. Using κₜ⁰ and β from SMS, the total OAM cavity linewidth (κₜ) and OAM ejection efficiency (κₑ/κₜ) through Eqn. (2) and Eqn. (3), can be predicted with only one free parameter q₀.

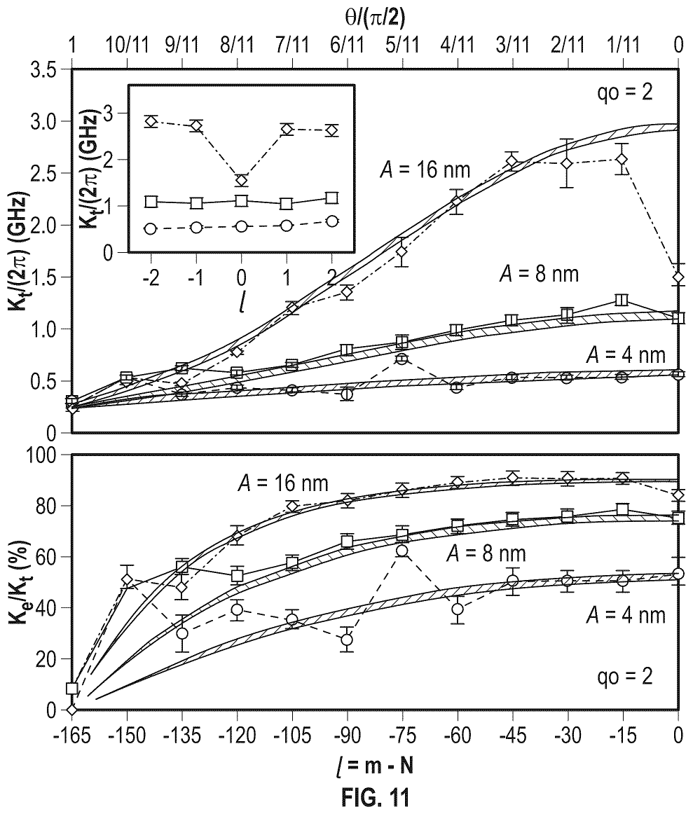

In the top panel of FIG. 11, the measured κₜ is plotted for a series of OAM devices, where N has been varied so that l ranges between about −165 and about 0, and for three different values of A. This experimental behavior agrees well with the model using the measured SMS values and q₀=2, as shown by the different curves in FIG. 11. The width of the curves represents the uncertainty in the predictions due to the uncertainties of κₜ⁰ that come from nonlinear least squares fits to the SMS transmission data. The predictions deviate from experiments near l=0 for large A, with the inset zooming in on this behavior with adjacent l from −2 to +2. This low-radiation-loss mode only happens at l=0, which has been used in integrated microrings for single-mode lasing, and its physics is related to a bound state in the continuum phenomenon induced by the photonic crystal structure.

The bottom panel of FIG. 11, shows the estimated extraction efficiency κₑ/κₜ as a function of l, where κₑ is experimentally determined from the measured κₜ (from the OAM devices) and the measured κₜ⁰ from the SMS devices. The experimental data is again matched well by the model, particularly for larger values of A, where the model results are shown as solid curves whose widths are determined by the aforementioned uncertainties in the experimental SMS data. The model contains no free parameter other than measured from experiments, except q₀=2, which represents the upward and downward OAM emission paths. Between the two panels of FIG. 11, the basic trend is that the estimated OAM ejection efficiency and total cavity linewidth both increase in moving from l=165 to l=0. The measured upper bound of OAM ejection efficiency and total cavity linewidth also scale with modulation amplitude A as expected, with the level of agreement between theory and experiments improving with increasing A. The estimated ejection efficiency reaches κₑ/κₜ=(80±3) % at l=−10⁵ and A=16 nm, with κₜ/(2π) of (1.19±0.02) GHz and thus Qₜ of (1.62±0.02)×10⁵. This efficiency is further increased to κₑ/κₜ=(90±1) % at l=−15, with a broadening of κₜ to (2.6±0.2) GHz governed by Eqn (3).

κₑ/κₜ in FIG. 11, represents the upper bound of the OAM ejection efficiency, not the directly measured OAM ejection efficiency. Any other coupling (i.e., loss) channels will contribute in the κₑ term and decrease the true OAM ejection efficiency. In particular, the generally good agreement between the measured total loss rate and that predicted by Eqn. 3 suggests that in the vast majority of cases (different modulation amplitude and l numbers), the coupling rate to any potential auxiliary channels is lower than the dominant loss channels focused on, that is, the intrinsic loss rate, waveguide coupling rate, and OAM ejection rate. Ultimately, a direct experimental verification of the OAM efficiency would be quite valuable. However, in this current scheme, such a verification is limited by many factors, including the high numerical aperture of the optics required to collect all of the emission for large l, the simultaneous presence of both CW and CCW (±1) emission, and the simultaneous emission in both the upwards (to air) and downwards (to substrate) propagation directions.

A factor that degrades the data quality yet is difficult to count into error bars arises from the technical difficulty to identify and fit resonances in the regime of doublet splittings on par with intrinsic loss rates (i.e., a merged doublet) properly. This factor is of note when the OAM emission rate is small at large l, but becomes negligible when the OAM emission rate is high at larger As and smaller l. Moreover, according to the fiber Bragg grating theory, total internal reflection (i.e., in-plane momentum outside of the cladding light cone) is expected to turn off the OAM emission channel (κₑ=0) for large l.

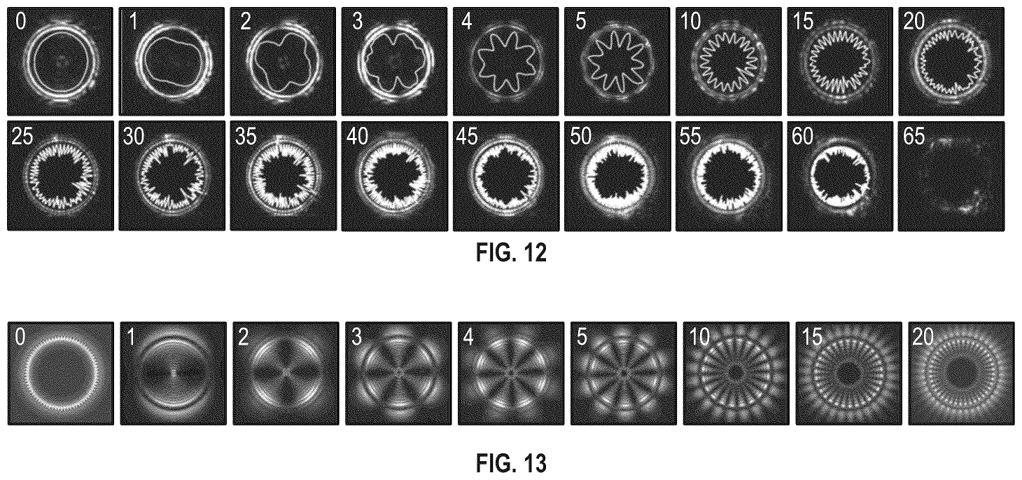

The imaging of the OAM microring modes is performed to confirm their spatial behavior as a function of l. As noted earlier, FIG. 6 shows the results for a microring with m=165 and N=169. Rather than a pure l=−4 state, the images are consistent with the emission containing both l=−4 and l=4 contributions, resulting in 4×2 antinodes in the measured distribution. Similar behavior has been observed in other OAM microcavity works, where it was attributed to ejection of light from a standing wave cavity mode. In the instant case, the ejection of both CW and CCW light could be due to surface roughness or waveguide facet reflection at the edge of the chip. The back-coupling rate of this reflection seems to be smaller than the total linewidth (unlike the SMS case), so a clear splitting of resonance is not observed in general. FIG. 12 displays the imaged OAM microrings fields near the surface of the cavities for a variety of OAM states with increasing l, as determined by analyzing the images and counting the number of anti-nodes. OAM states from |l|=0 to |l|=60 are clearly observed; the observation of even higher-order OAM is likely limited by the numerical aperture of the imaging system. In these measurements, devices with l=1 to 3 had an additional SMS modulation imprinted on the device pattern to ensure standing wave modes for better interference visibility; this method is discussed further in the next section.

Dipole excitation is used to excite standing-wave WGMs to have a beating pattern in the intensity for OAM. FIG. 13 shows that the simulation results qualitatively agree with the observed patterns. Plotted in FIG. 13 is the Poynting vector projected on the vertical direction, that is, S_{z}=(E×H)·\hat{z}, in the mid-field above the surface of the microring.

The observed Qs, in addition to following the predicted trends based on the SMS devices and Eqns. (1)-(3), are more than two orders of magnitude higher than those demonstrated in previous OAM generators based on microring resonators while simultaneously exhibiting a high estimated ejection efficiency. For example, the l=60 mode has Qₜ≈5×10⁵ and an estimated ejection efficiency of 40% for A=4 nm and Qₜ≈2×10⁵ and an estimated ejection efficiency of 65% for A=8 nm. Such high-Qs are particularly promising for enhancing light-matter interactions, for example, to create Purcell-enhanced quantum light with OAM from a quantum emitter, to realize coherent spin-photon interfaces, or to mediate nonlinear wave mixing interactions such as Kerr comb generation and entangled-photon pair generation with the output fields encoded in OAM states.

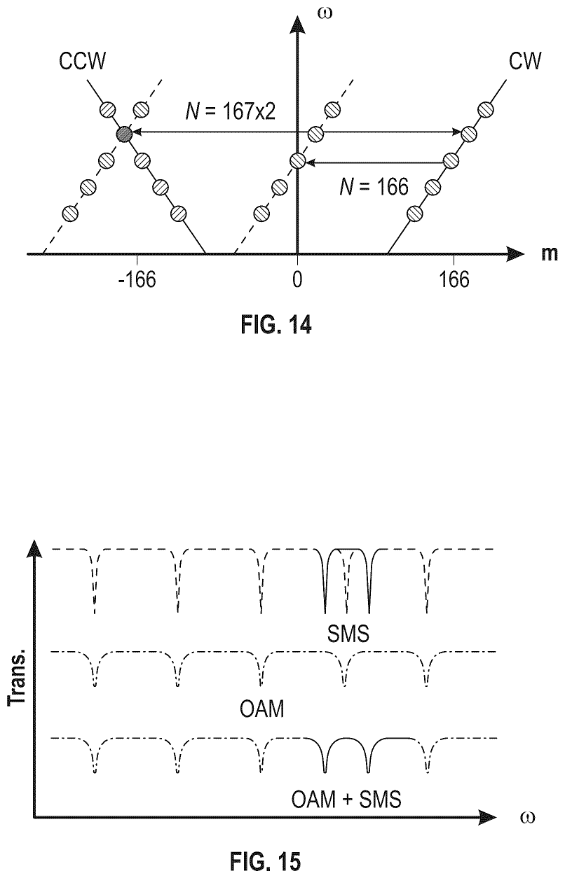

Combining SMS and OAM coherently. So far, a single-period grating for either SMS or OAM has been used. Since both scattering processes are coherent, it is possible to combine them. For example, combining multiple SMS periods through a multi-period grating (i.e., by simply adding up modulation with different N s) is practical and retains high cavity quality factors. In aspects, a dual-period grating is used to implement SMS and OAM together. For comparison, three cases with a fixed number of modulation periods for OAM at N=166 and a varying number of modulation periods for SMS at N=2×{166, 167, 168} were studied. In the band diagram displayed in the in FIG. 14, the case in which the m=166 mode is ejected to an l=0 OAM state and the m=±167 modes are coupled via SMS is illustrated. The resulting cavity transmission is illustrated in the bottom panel, where SMS splits the m=167 mode without affecting linewidths, and OAM broadens all the cavity linewidths. Having both SMS and OAM should result in a coherent summation of both effects. FIG. 15 is a diagram that shows the expected transmission spectrum of the band diagram of FIG. 14

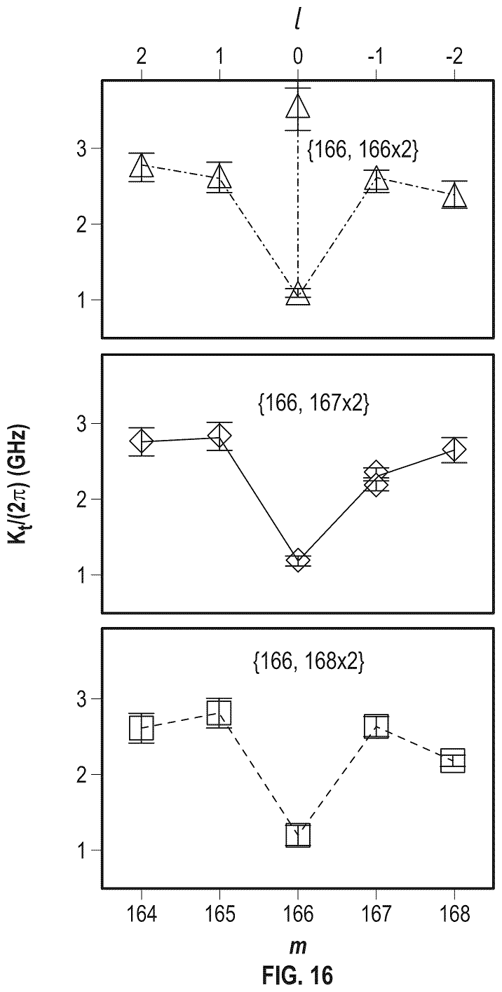

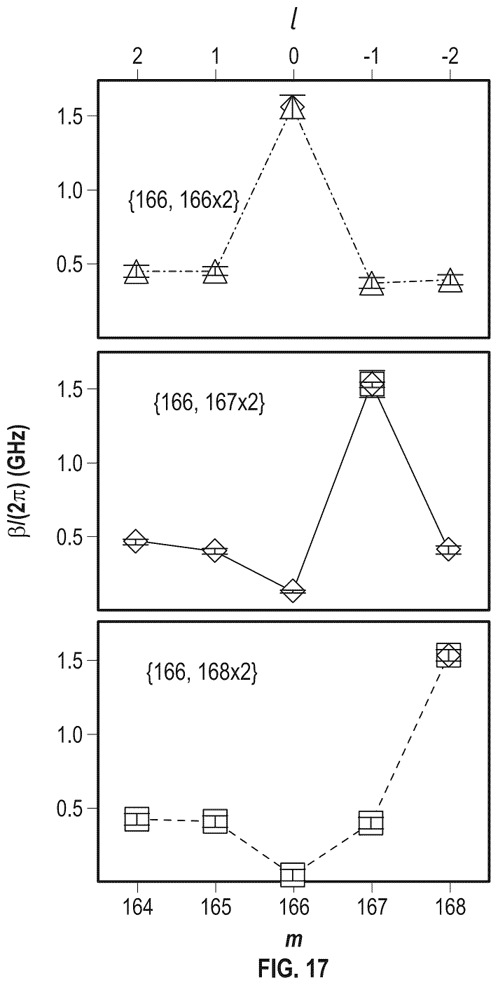

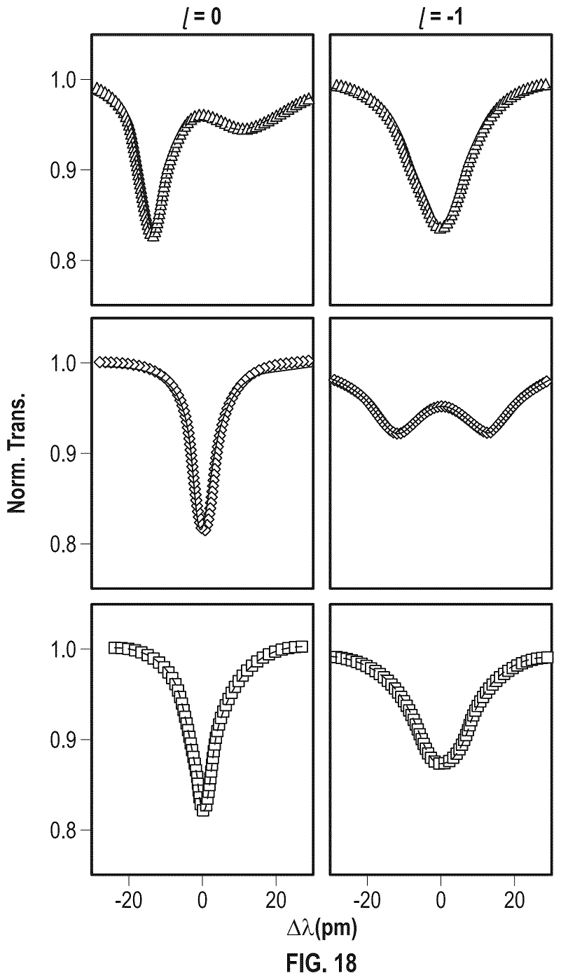

Referring to FIGS. 16-18, the implementation of coherent OAM and SMS in three fabricated devices, is examined. The focus is not on a single azimuthal order mode but instead on the examination of a series of adjacent azimuthal order modes. FIG. 18 shows representative transmission spectra (for l=0 and l=−1, or equivalently m=166 and m=167). FIGS. 17 and 18 show the extracted loaded cavity line widths (κₜ) created by OAM in the left column, and the right column shows the mode splitting (β) created by SMS. The overall behavior observed is consistent with the expectation for coherent superposition of the OAM and SMS effects. The mode splittings are largest for the azimuthal mode targeted by the SMS modulation, while the OAM modulation is set to eject the l=0 mode and consistently shows a reduction in dissipation.

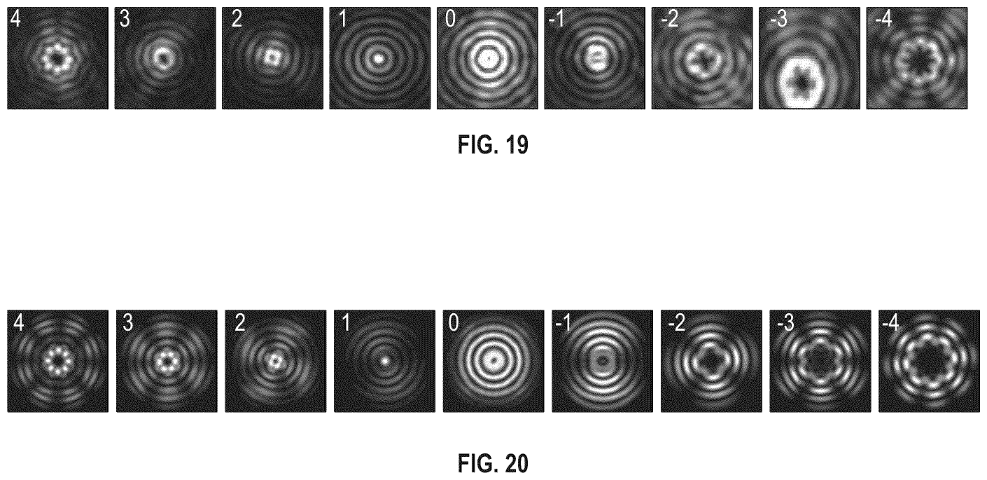

With or without SMS, the OAM devices always show standing-wave patterns in images taken both at the top surface of the microring, as shown in FIG. 12, and in the far-field, as shown in FIG. 19. These standing-wave images are not an issue in many quantum systems, as the emitted light is intrinsically in both clockwise and counter-clockwise directions. The measured far-field images are in good agreement with the results of finite-difference time-domain simulations that incorporate a standing wave mode pattern, as shown in FIG. 20.

The results indicate that OAM emission does not have to lead to a mode splitting or a considerably broadened linewidth. For example, the popular square grating is effectively a composition of multiple frequency components, while only the fundamental frequency grating (as employed with a sinusoidal modulation) is essential for OAM. The potential role that such multi-frequency components play on excess loss and backscattering is still an open question, and to this end, the approach from SMS to OAM can be extended to these structures to perform a quantitative evaluation.

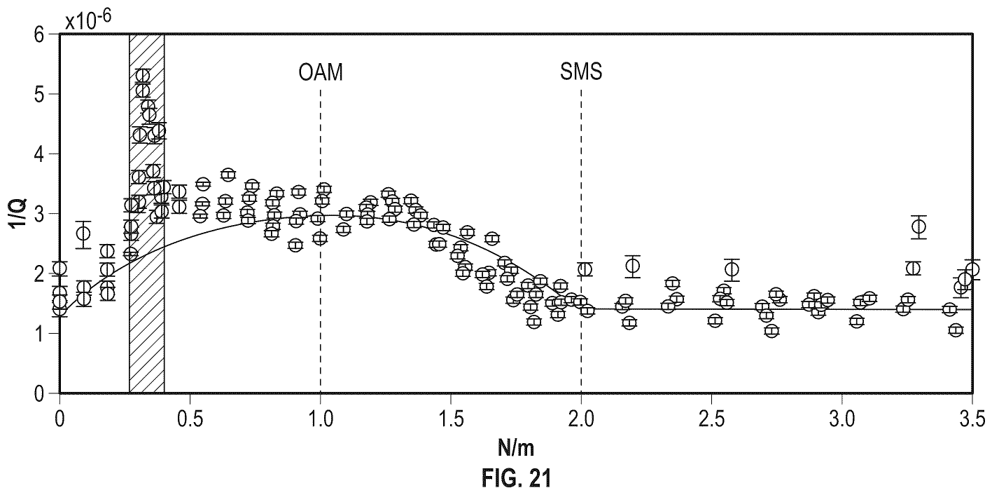

Referring to FIG. 21, a graph illustrating quality factor Q measurements across a full range of ratios of the number of modulation periods N to azimuthal mode number m is shown. FIG. 21 includes data on N/m from about 0 to about 4. The narrow peak on top of the broad response is identified to be related to a surface mode. From this data, that is, the response at one wavelength for many devices, the full spectral response can be derived for all wavelengths for one PhCR device. A complete understanding of the PhCR's spectral response is useful in its applications in wide-band nonlinear optics like four-wave mixing Bragg scattering, widely-separated optical parametric oscillation, and second/third-harmonic generation.

In aspects, the system 10 may be used to quantitatively estimate the rate of vertical OAM emission by using the link of OAM and SMS by Eqn. 1 and Eqn. 2, as well as the full spectral response prediction on the FIG. 21. An example of usage can follow FIGS. 10 and 11, to use SMS measurements to predict OAM. FIG. 21 may be used to estimate the rates of vertical OAM emission at all wavelengths of light based.

In aspects, the OAM loss rate may be calculated and/or estimated by the SMS rate (e.g., splitting). Initially, a SMS resonator is selected with a known value. Next, the design of the OAM device may be determined based on equations 1 and 2, which provide the parameters for the design of the OAM device.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different example embodiments provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for generating highly twisted states of light, comprising:
a light source configured to pump light; and
a photonic device configured to enable generation of highly twisted states of light, the photonic device including:
a waveguide configured to couple to the light source; and
a microresonator coupled to the light source via the waveguide, wherein the microresonator operates in whispering gallery mode (WGM),
wherein the microresonator includes a photonic crystal ring (PhCR) configured to enable generating highly twisted states of light, and
wherein the microresonator includes a photonic crystal grating.

2. The system of claim 1, wherein a quality factor of the microresonator is greater than or equal to about 10⁵.

3. The system of claim 2, wherein the WGM includes an azimuthal order m representing angular momentum of the WGM, and a grating with N periods around a circumference of the PhCR.

4. The system of claim 3, wherein the microresonator is configured to eject light carrying orbital angular momentum (OAM) with an angular momentum number (l)=m−N.

5. The system of claim 3, wherein the microresonator is configured to generate OAM states up to an l of about 60, with an estimated upper bound of OAM ejection efficiency of up to about 90%.

6. The system of claim 3, wherein when
$$m = \frac{N}{2} ,$$
a clockwise WGM and a counterclockwise WGM are coupled by the photonic crystal grating.

7. The system of claim 1, wherein the microresonator and the waveguide are on a common substrate.

8. The system of claim 1, wherein an inside radius of the PhCR is modulated as Rᵢₙ=Rᵢₙ⁰+A cos(Nφ), where Rᵢₙ⁰ is an average inside radius, A is a modulation amplitude, and φ is an azimuthal angle.

9. The system of claim 1, wherein the grating includes periodical modulation in one dimension.

10. The system of claim 1, wherein an interaction rate between two counter-propagating WGMs is mediated by selective mode splitting (SMS).

11. A method for generating highly twisted states of light, comprising:
pumping a light from a light source; and
coupling, by a waveguide, the light source to a photonic device configured to enable generating highly twisted states of light, the device including: a waveguide configured to couple to the light source; and a microresonator operating in whispering gallery mode (WGM), wherein the microresonator includes a photonic crystal ring (PhCR) configured to enable generating highly twisted states of light, and a photonic crystal grating.

12. The method of claim 11, wherein the WGM includes an azimuthal order m representing angular momentum of the WGM, and a grating with N periods around a circumference of the PhCR.

13. The method of claim 11, further comprising:
ejecting, by the microresonator, light carrying orbital angular momentum (OAM) with an angular momentum number (l)=m−N.

14. The method of claim 11, further comprising:
generating OAM states up to an l of about 60, with an estimated upper bound of OAM ejection efficiency of up to about 90%.

15. The method of claim 11, further comprising:
coupling, by the photonic crystal grating, when
$$m = \frac{N}{2} ,$$
a clockwise WGM and a counterclockwise WGM.

16. The method of claim 11, further comprising:
Mediating, by selective mode splitting (SMS), an interaction rate between two counter-propagating WGMs.

17. A method for quantitatively estimating a rate of vertical orbital angular momentum (OAM) emission includes:
selecting a selective mode splitting (SMS) reference microresonator with a known SMS rate; and
estimating a rate of vertical OAM emission based on a link between OAM and SMS based on the following equations to predict OAM loss in a photonic device for generating highly twisted states of light:
$${κ}_{e} = {q}_{0} \frac{2 β}{\sqrt{{F}_{t} / 2 π}} cos ( θ )$$
$$and$$
$${κ}_{t} = {κ}_{t}^{0} + 2 q \sqrt{{κ}_{t}} ,$$
wherein the photonic device includes:
a waveguide configured to couple to a light source; and
a microresonator coupled to the light source via the waveguide, wherein the microresonator operates in whispering gallery mode (WGM),
wherein the microresonator includes a photonic crystal ring (PhCR) configured to enable generating highly twisted states of light,
wherein the microresonator includes a photonic crystal grating, and
wherein a strength of the coupling from the WGM to a free-space OAM mode is quantified by a rate κₑ.

18. The method of claim 17, wherein a quality factor of the microresonator is greater than or equal to about 10⁵.

19. The method of claim 18, wherein the WGM includes an azimuthal order m representing angular momentum of the WGM, and a grating with N periods around a circumference of the PhCR.

20. The method of claim 17, wherein an inside radius of the PhCR is modulated as Rᵢₙ=Rᵢₙ⁰+A cos(Nφ), where Rᵢₙ⁰ is an average inside radius, A is a modulation amplitude, and φ is an azimuthal angle.
